(19) United States
(12) Patent Application Publication
(10) Pub. No.: US 2004/0210477 A1
(43) Pub. Date: Oct. 21, 2004

(54) Promotional display for promoting the sale of retail products

(75) Inventor: Dale F. McIntyre, Honeoye Falls, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/417,305

(22) Filed: Apr. 16, 2003

(51) Int. Cl. G06F 17/60

(52) U.S. Cl. 705/14

(57) ABSTRACT

A method for promoting the sale of a product for a potential customer at a predetermined location includes providing an electronic display and electronic display control unit for controlling the display at the predetermined location proximate to where at least one product is being displayed, such electronic display control unit having an electronic address and being adapted to be connected to a network; a product supplier providing promotional information via the network to a server related to at least one product; and providing identifiers on the at least one product being displayed.

### FIELD OF THE INVENTION

The present invention relates to retail promotion of products for displaying promotional material to positively affect the retail sales of an item.

### BACKGROUND OF THE INVENTION

Recent advances in computer hardware, manufacturing processes, operating systems, and software design methodologies have made possible new generations of point-of-sale (POS) terminals based on personal computer (PC) technologies. Networking such terminals provides them with a wealth of information about a customer, their buying habits, and potentially their future buying interests.

Such a system offered for commercial sale is the Catalina Marketing Network® by the Catalina Marketing Corporation. This system enables a retailer to present advertisements to a consumer for products related to those products that they are currently in the process of purchasing. As product UPC's are scanned by store point-of-sale systems, the Catalina Marketing Network® instantly identifies individual products and/or combinations of products that fit targeting criteria. In real time, this information is sent to the thermal printer sitting next to the check out register, and customized offers and incentives are delivered directly to the intended consumer. At this point, however, the consumer is leaving the store and the printed information must be retained by the consumer to initiate a future purchase related to the printed information.

Similarly, U.S. Pat. No. 6,401,074 B1 to Sleeper describes such a POS terminal that further includes the ability to show promotional material including video and audio to a consumer during a retail transaction. Such a system suffers from a similar fate as described above because the consumer is involved in a retail transaction, and to take advantage of the promotional material must complete the retail transaction and then re-enter the store. Furthermore, the consumer is distracted from viewing the promotional material by their participation in the important financial transaction to pay for their goods.

In the International Patent application WO 01/41033 A2 to Franklin et al., another POS advertisement system is described. In this system, a consumer is identified by a loyalty card and is shown advertisements based on past purchase history or items currently being purchased. In the event that a loyalty card is not held by a consumer, advertisement display is a function of the first item purchased that has a corresponding advertisement. In the event that the items being purchased do not have a corresponding advertisement to display, the system defaults to an advertisement based on the date and time of purchase. The advertisements are stored on a remote database and a subsequent playlist is built to correlate to a certain section of a store, such as showing advertisements for sporting goods in a checkout area proximate to the retail space assigned to sporting goods. Again, such a system promotes a variety of related products by inference and only influences a potential future purchase since the consumer is trapped in a retail checkout queue.

In yet another POS system described in International Patent application WO 00/77722 A1 to Schumacher et al., a running sequence of graphic presentations (advertisements) is displayed in a continuous fashion on a display visible to a consumer during a retail transaction or checkout process. The sequence of advertisements is interrupted by the scanning of an item to be purchased wherein the display shows an alphanumeric representation of the product and the price of the product. After a short delay following the display of the price, the display returns to displaying the sequence of advertisements. The success of the system is contingent upon the consumer's memory of the viewing of the promotional material and recalling it at a point in the future when they are prepared to consider purchasing. In fact, all of the promotional display systems referenced above suffer from the inability to provide extended in-depth promotional material to a consumer, as they are only within view of the display for a relatively short time to complete their retail transaction and leave the store.

In another aspect of the prior art, wholesale distributor BJ's Wholesale makes use of small TV/VCR combination appliances running a pre-produced video tape containing an infomercial related to a specific item that the store is trying to promote the sales of. While capable of providing detailed information related to a specific product, such a system still requires operator intervention to change the tape and provide maintenance on an apparatus whose very design degrades the visibility of the promotional material upon each viewing of the tape. Furthermore, due to the need to produce, distribute, and install videotapes, the system employed by BJ's can't react fast enough to changing market conditions or updated product promotional material. Such a system also produces a waste stream of out-dated promotional material much like a conventional in-store promotional display predicated on print collateral.

Therefore, there is a need for a retail promotional display system that can automatically configure itself to promote any specific product or products carried by a specific retail store. There is also a further need for such a retail promotional display system to be capable of displaying a plurality of promotional content specific to that product to which it is configured wherein such content can be updated, added to, or substituted by the product manufacturer or a supplier representing the manufacturer in real time. Such a retail promotional system must also not produce a physical waste stream of used promotional material.

### SUMMARY OF THE INVENTION

It is an object of the present invention to effectively provide product promotional information to a potential customer.

This object is achieved by a method for promoting the sale of a product for a potential customer at a predetermined location, comprising the steps of:

a) providing an electronic display and electronic display control unit for controlling the display at the predetermined location proximate to where at least one product is being displayed, such electronic display control unit having an electronic address and being adapted to be connected to a network;

b) a product supplier providing promotional information via the network to a server related to at least one product;

c) providing identifiers on the at least one product being displayed;

d) reading the identifier on the at least one product being displayed at the predetermined location corresponding to the electronic display and providing the electronic address and product identification information of the at least one product to the server via the network; and

e) the server providing, in response to the read identifier and the electronic address of the electronic display control unit, via the network, the promotional information to the electronic display control unit which causes the promotional information to be displayed on the electronic display which can be read by the potential customer.

### ADVANTAGES

An advantage of the present invention is that a potential customer at a retail location can receive promotional information related to products, which can stimulate the sale of such products.

The promotional information can be updated by suppliers to provide the most current, up-to-date information over a network related to the product being offered for sale.

By using a display in accordance with the method set forth above, it is no longer necessary to print promotional information, as it can be readily read from the display by a potential customer, thereby eliminating the paper waste associated with updating promotional printed material.

### BRIEF DESCRIPTION OF THE DRAWINGS

FIG. 1 is a schematic of a retail POP display system having an electronic display and an electronic display control unit in accordance with the present invention;

FIG. 2 is a schematic diagram showing a promotional content management system including a communication network;

FIG. 3 is a flow chart showing a method of providing promotional information about a product to the electronic display control unit;

FIG. 4 is a flow chart showing a method of updating the promotional content related to a product;

FIG. 5 is a schematic diagram similar to FIG. 2 but showing another promotional content management in accordance with the present invention; and

FIG. 6 is another schematic of a retail POP display system having an electronic display and an electronic display control unit in accordance with the present invention.

### DETAILED DESCRIPTION OF THE INVENTION

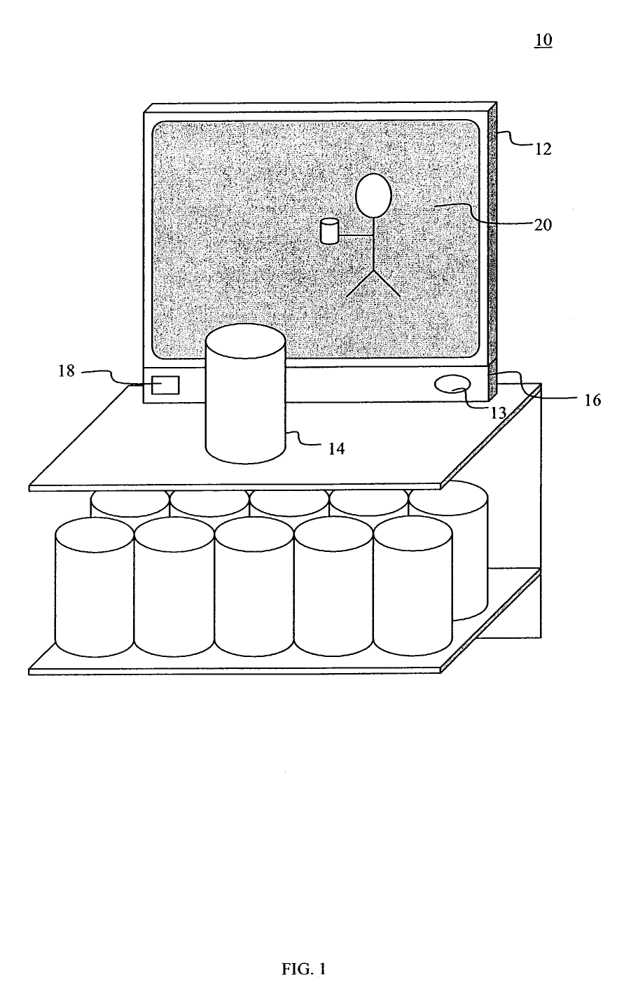

In FIG. 1, a retail point-of-promotion (POP) system 10 is shown with an electronic display 12 featuring promotional content 20 which is used to affect the positive purchase behavior with respect to a particular product 14. Also associated with the electronic display 12 are speakers 13. Product 14 includes an identification tag (not shown) that can be something as common as a bar code on a label or a radio frequency (RF) tag which is incorporated in the assembly of a label and is becoming increasingly popular in product manufacturing. Particularly useful in POP system 10 are electronic displays 12 manufactured as flat panel displays such as those made by Apple Computer in their Cinema Display series which incorporate active matrix color LCD technology or the recently introduced organic light emitting diode (OLED) technology manufactured by Eastman Kodak Company. It will be appreciated by one skilled in the art that such an electronic display 12 can be fabricated in any number of existing and emerging technologies other than active matrix color LCD or OLED without deviating from the scope of the invention.

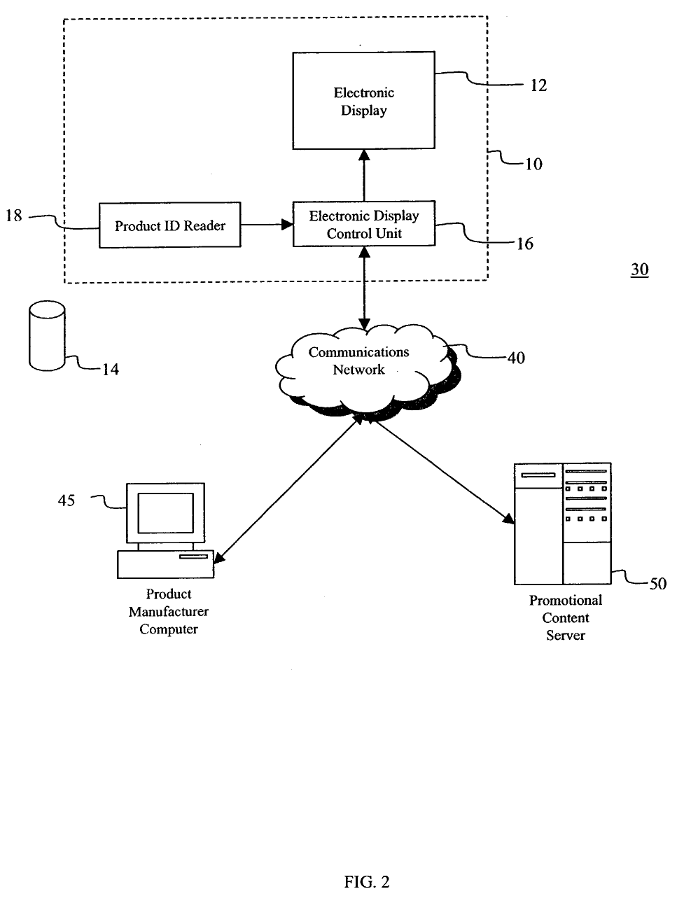

Operably connected to the electronic display 12 is an electronic display control unit 16 for receiving, storing, and conditioning signals for displaying the promotional content 20 with respect to product 14. The electronic display control unit 16 can also receive digital audio information which can be sent to the speakers 13 at the same time that video information is sent to the electronic display 12. The audio information can be played without the provision of any video information. The electronic display control unit 16 can be, for example, a personal computer which includes components and circuitry for accessing a network such as the Internet, mass storage devices for storing promotional content 20, and circuitry for controlling the electronic display 12. It will be understood that an effective electronic display control unit 16 can be made from a subset of what is typically found in a personal computer. However, the high volume production of personal computers (and thus their low price) lends them to be effectively adapted to tasks that do not require all their elements. Electronic display control unit 16 communicates with communications network 40 (see FIG. 2) via a commonly know communications standard such as transport communication protocol/internet protocol (TCP/IP) that permits communication between devices with assigned electronic addresses.

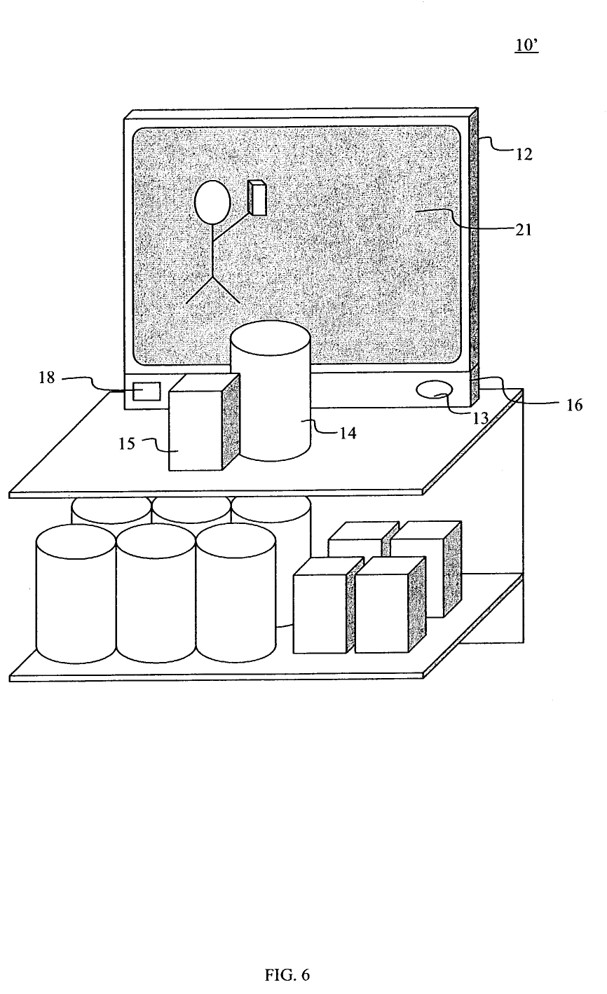

Included in the retail POP system 10 is a product identification (ID) reader 18 which, by way of example but not limitation, can be a bar code reader or preferably a radio frequency identification (RFID) reader. An RFID reader has less sensitivity with respect to the placement of product 14 relative to the product ID reader 18. This advantage is amplified when two or more products are placed proximate to product ID reader 18 and co-promoted by the retail POP system 10 as will be described later with respect to FIG. 6. Product ID reader 18 is shown in FIG. 1 to be physically integrated into electronic display control unit 16. While this is a preferable arrangement, an alternative arrangement (not shown) can include a product ID reader 18 that is a physically separate device that is only operably connected to electronic display control unit 16.

Turning now to FIG. 2, retail POP system 10 is shown connected into a promotional content management system 30 that further includes a communications network 40 such as the Internet, a computer 45 belonging to a product supplier, such as a product manufacturer or product distributor adapted to provide promotional content for various products, and a promotional content server 50 for receiving, storing, and serving promotional content to the addressable electronic display control unit 16 which places requests for promotional content 20 in response to retail POP system 10 configured with product 14.

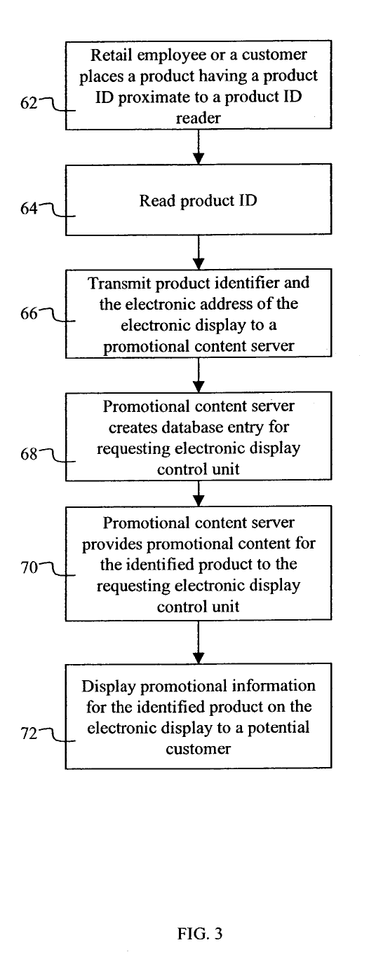

In FIG. 3, a flow chart depicts the operation of the promotional content management system 30. Beginning in step 62, a retail employee or clerk configures the retail POP system 10 by placing product 14 within range of the product ID reader 18 where the product ID is read (step 64). If the retail POP system 10 is left unconfigured (without a specific product), customers can approach with a product in question and place it near the reader. In either case, the electronic display control unit 16 provided with the product ID of product 14 by the product ID reader 18 opens a network connection and transmits (step 66) the product ID of product 14 along with the electronic address of the electronic display control unit 16 to the promotional content server 50.

Promotional content server 50 creates (step 68) a record in an electronic database corresponding to the request for promotional content. This data can be used to bill the product supplier for an amount corresponding to the length of time their product is promoted by providing displays of promotional information to different customers. Data collected in the database includes at least the electronic address of the requesting electronic display control unit 16, the date of the initial promotion request, the date of the last update to the promotional content, the particular product promoted, and a promotional rate previously negotiated by the product supplier.

In response to the request for promotional content, the promotional content server 50 provides (step 70) promotional content 20 for product 14 to the electronic address of the electronic display control unit 16 previously transmitted with product ID of product 14. Having received and stored the transmitted promotional content 20, electronic display control unit 16 causes promotional content 20 to be displayed (step 72) on electronic display 12. It will be understood that promotional content 20 can include various combinations of images and sound that are only limited by the imagination and some examples include extended promotional content such as infomercials, more common promotional video content such as TV commercials, still image(s) with or without an accompanying soundtrack, or audio promotional content without video images at all.

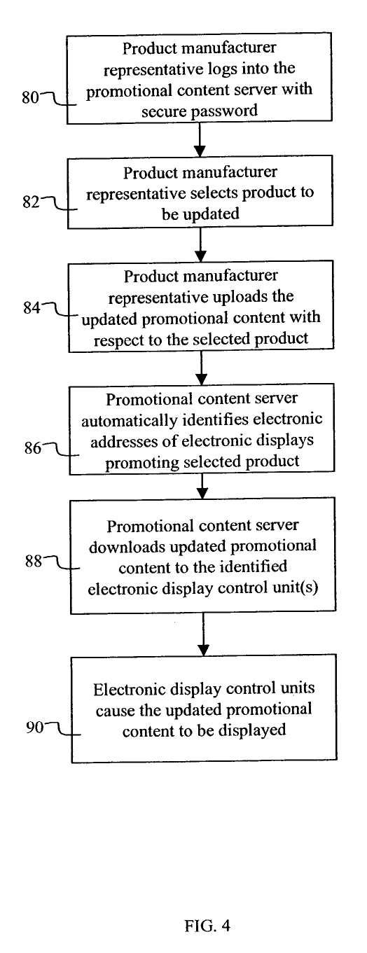

Turning now to FIG. 4, a flow chart describes the process by which a product supplier provides updated promotional content 20 for product 14 to the promotional content server 50 and thus automatically updates all the electronic display control unit(s) 16 for their associated electronic displays 12 that are currently promoting product 14. Computer 45 opens a network connection via communications network 40 to the promotional content server 50. Using an established login procedure usually accompanied by a password to protect security of the promotional content, a representative of the product supplier, using computer 45, logs into (step 80) the promotional content server 50. Selecting (step 82) the product to update, the product supplier's representative interacting with the promotional content server 50, uploads (step 84) the updated promotional content with respect to the selected product. After receiving promotional information, each electronic display control unit 16 maintains such promotional information for subsequent use by future customers. However, after confirming a successful upload of the updated promotional content, the promotional content server 50 accesses its database to identify (step 86) the electronic addresses of all the electronic display control unit(s) 16 and associated electronic display(s) 12 currently promoting the product whose promotional content was just updated. Promotional content server 50 proceeds to establish communication with each identified electronic display control unit(s) 16 and downloads (step 88) the updated promotional content to the respective electronic display control unit(s) 16, which in turn display (step 90) the updated promotional content on the associated electronic display(s) 12.

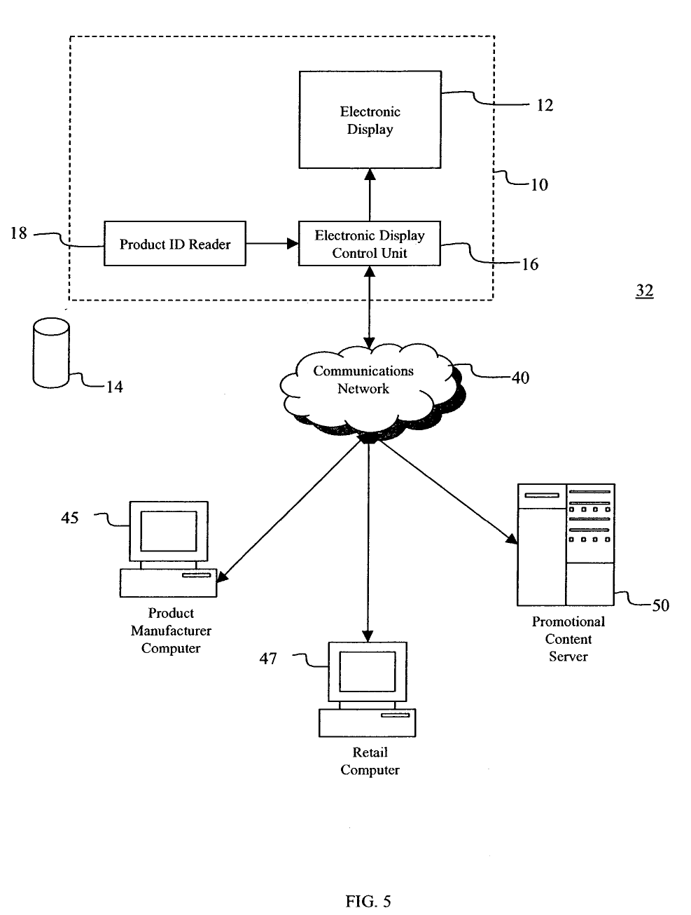

In FIG. 5, a retail computer 47 has been added to an alternate promotional content management system 32. Retail computer 47 is used by the retailer to approve or reject the proposed and/or updated promotional content for the retail POP system(s) 10 used within their retail location. Retailers in this embodiment are provided with an approval mechanism to prevent the display of promotional content that in their opinion is not appropriate for their clientele. In this embodiment, the promotional content server 50 maintains at least two additional fields within the database that tie a specific electronic display control unit 16 to a specific retailer and tracks the approval status by the retailer for that specific promotional content. Upon retailer approval, the automated update process can proceed as described with respect to FIG. 4.

Turning now to FIG. 6, a modified retail POP system 10′ (like numbers indicating like parts and operation) shows the addition of a second product 15 proximate to product 14 and the product ID reader 18. Related to product 15, promotional content 21 is displayed within electronic display 12 and, in the preferred embodiment, is alternately displayed along with promotional content 20 for promoting both products 14 and 15. In this manner, an effective promotional display can be created for promoting a plurality of products that may or may not be functionally related. Furthermore, it will be recognized that such a retail POP system 10′ can be set up to allow customers to approach with products of interest and, by placing them within the range of the display, cause the display to present them with promotional content for each of the proximate products.

The invention has been described in detail with particular reference to certain preferred embodiments thereof, but it will be understood that variations and modifications can be effected within the spirit and scope of the invention.

### PARTS LIST

10 point-of-promotion (POP) system

10′ modified retail POP system

12 electronic display(s)

13 speakers

14 product

15 second product

16 electronic display control unit

18 product identification (ID) reader

20 promotional content

21 promotional content

30 content management system

32 promotional content management system

40 communications network

45 computer

47 retail computer

50 content server

62 block

64 block

66 block

68 block

70 block

72 block

80 block

82 block

84 block

86 block

88 block

90 block

What is claimed is:

1. A method for promoting the sale of a product for a potential customer at a predetermined location, comprising the steps of:
a) providing an electronic display and electronic display control unit for controlling the display at the predetermined location proximate to where at least one product is being displayed, such electronic display control unit having an electronic address and being adapted to be connected to a network;
b) a product supplier providing promotional information via the network to a server related to at least one product;
c) providing identifiers on the at least one product being displayed;
d) reading the identifier on the at least one product being displayed at the predetermined location corresponding to the electronic display and providing the electronic address and product identification information of the at least one product to the server via the network; and
e) the server providing, in response to the read identifier and the electronic address of the electronic display control unit, via the network, the promotional information to the electronic display control unit which causes the promotional information to be displayed on the electronic display which can be read by the potential customer.

2. A method for promoting the sale of different products for a potential customer at a predetermined location, comprising the steps of:
a) providing an electronic display and electronic display control unit for controlling the display at the predetermined location proximate to where the different products are being displayed, such electronic display control unit having an electronic address and being adapted to be connected to a network;
b) product suppliers providing promotional information via the network to a server related to the different products;
c) a customer causing the identification of a desired product and such product identification and electronic address of the display being sent to the server; and
d) the server, in response to the identification of the desired product and the electronic address of the electronic display control unit, sending via the network, the promotional information to the electronic display control unit which causes the promotional information to be displayed on the electronic display related to the desired product which can be read by the potential customer.

3. The method of claim 2 further including providing a product identifier on the product and, in step c), the customer causing a product ID reader to read the product identifier to identify the product.

4. The method of claim 3 wherein the product identifier is a barcode or a radio frequency identification (RFID) tag.

5. The method of claim 3 further including the step of billing the product supplier for an amount corresponding to the length of time their product is promoted by providing displays of promotional information to different customers.

6. A method for promoting the sale of different products by a seller for potential customers at a predetermined location, comprising the steps of:
a) providing an electronic display and an electronic display control unit for controlling the display at the predetermined location proximate to where the different products are being displayed, such electronic display control unit having an electronic address and being adapted to be connected to a network;
b) product supplier providing promotional information related to the different products via the network to a server;
c) the seller determining if the promotional information is suitable for being viewed by their customers;
d) a customer causing the identification of a desired product and such product identification and electronic address of the electronic display control unit being sent to the server; and
e) the server, in response to the identification of the desired product and the electronic address of the electronic display control unit, sending via the network, the promotional information to the electronic display control unit which causes the promotional information to be displayed on the electronic display related to the desired product which can be read by the potential customer.

7. The method of claim 6 further including the step of billing the product supplier for an amount corresponding to the length of time their product is promoted by providing displays of promotional information to different customers.

8. A method for promoting the sale of different products for a potential customer at a predetermined location, comprising the steps of:
a) providing an electronic display, associated speakers, and an electronic display control unit for controlling the electronic display or audio provided to the speakers at the predetermined location proximate to where the different products are being displayed, such electronic display control unit having an electronic address and being adapted to be connected to a network;
b) product supplier providing promotional information via the network to a server related to the different products;
c) a customer causing the identification of two or more desired products and such desired products identification and electronic address of the electronic display control unit being sent to the server; and
e) the server, in response to the identification of the desired products and the electronic address of the electronic display control unit, sending via the network, the promotional information being video or audio, or audio without video, to the electronic display control unit which causes the promotional information to be displayed on the electronic display or played by the speakers of the electronic display control unit, or both.

9. The method of claim 8 further including the step of billing the product supplier for an amount corresponding to the length of time their product is promoted by providing displays of promotional information to different customers.

10. A method for promoting the sale of a product for a potential customer at predetermined locations, comprising the steps of:
a) providing a plurality of electronic display and electronic display control units, each for controlling an associated electronic display at one of the predetermined locations and each being located proximate to where at least one of the same products is being displayed, each such electronic display control unit having a different electronic address and being adapted to be connected to a network;
b) a product supplier providing promotional information via the network to a server related to at least one product;
c) providing identifiers on the at least one product being displayed;
d) reading, at each of the predetermined locations, the identifier on the at least one product being displayed at a predetermined location corresponding to a particular electronic display and providing the electronic address of each predetermined location and product identification information of the at least one product to the server via the network;
e) the server providing, in response to the read identifier and the electronic address of the electronic display control unit(s), via the network, the promotional information to the electronic display control unit(s) which causes the promotional information to be displayed on the electronic display(s) which can be read by the potential customer or other subsequent potential customers; and
f) the server, after receiving updated promotional information related to a product, sending such information to each of the predetermined electronic display control units that had previously received the promotional information related to the at least one product so that the most updated promotional information is available to the customers.
